(19) United States
(12) Patent Application Publication
(10) Pub. No.: US 2012/0220289 A1
(43) Pub. Date: Aug. 30, 2012

(54) Method and Apparatus for Detecting Relative Object Position

(76) Inventor: Christopher Bellmare, Newington, NH (US)

(21) Appl. No.: 13/399,472

(22) Filed: Feb. 17, 2012

Related U.S. Application Data
(60) Provisional application No. 61/446,755, filed on Feb. 25, 2011.

(51) Int. Cl. H04W 24/00; H04W 68/00

(52) U.S. Cl. 455/423

(57) ABSTRACT

An object position detection apparatus and a method of notifying a relative object position are provided. The object position detection apparatus includes a computerized device having a wireless receiver. A wireless transmitting element is located remotely from the computerized device, wherein the computerized device is paired with the wireless transmitting element through a wireless communication connection. A detection element is within the computerized device, the detection element positioned to detect a break in the wireless communication connection, wherein the break in the wireless communication connection corresponds to a location of the wireless transmitting element that is beyond a predetermined distance from the computerized device. A notification element is in communication with the detection element, wherein the notification element produces a notification of the detected break in the wireless communication connection.

### CROSS REFERENCE TO RELATED APPLICATION

This application claims benefit of U.S. Provisional Application Ser. No. 61/446,755 entitled, “Method and Apparatus for Detecting Relative Object Position” filed Feb. 25, 2011, the entire disclosure of which is incorporated herein by reference.

### FIELD OF THE DISCLOSURE

The present disclosure is generally related to object positioning and more particularly is related to a method and apparatus for detecting relative object position.

### BACKGROUND OF THE DISCLOSURE

The ability to detect a position of an object is often sought after by individuals and companies. There are some systems or devices that allow for object position detection, but these systems are expensive, difficult to implement and have many shortcomings. For example, global positioning systems (GPS) provides location detection, but are very costly and can only function in settings where the GPS receiver has an unobstructed line of sight to at least four GPS satellites. Thus, GPS devices are not reliable indoors, in bad weather, and even under the cover of trees or other foliage. GPS devices and other location devices are also very bulky, and commonly require large computerized components that are difficult to incorporate into everyday items. Because of this inconvenience, many people may forget to use GPS devices, or may opt to not use them.

Additionally, GPS only locates a position of an object when it is programmed or requested to do so, not based upon the object's relative position to another object. For example, GPS systems can provide the location of a runaway dog with a GPS receiver in the dog's collar. However, this is commonly only done after the dog has been deemed missing. Commonly, there may be a substantial period of time between when the dog went missing and when a location is determined with the GPS. During this time, the dog's collar with the GPS receiver may have been removed or broken. Other systems, such as RFID-based systems or ultrasonic-based systems, have similar shortcomings.

Thus, a heretofore unaddressed need exists in the industry to address the aforementioned deficiencies and inadequacies.

### SUMMARY OF THE DISCLOSURE

Embodiments of the present disclosure provide an object position detection apparatus. Briefly described, in architecture, one embodiment of the apparatus, among others, can be implemented as follows. A computerized device has a wireless receiver. A wireless transmitting element is located remotely from the computerized device, wherein the computerized device is paired with the wireless transmitting element through a wireless communication connection. A detection element is within the computerized device, wherein the detection element is positioned to detect a break in the wireless communication connection, wherein the break in the wireless communication connection corresponds to a location of the wireless transmitting element that is beyond a predetermined distance from the computerized device. A notification element is in communication with the detection element, wherein the notification element produces a notification of the detected break in the wireless communication connection.

The present disclosure can also be viewed as providing systems for alerting a relative location of a living being. Briefly described, in architecture, one embodiment of the system, among others, can be implemented as follows. The system includes a computerized device having a wireless receiver. At least one wireless transmitting element is attached to a living being, wherein the living being is located remotely from the computerized device and is movable independent of the computerized device, wherein the computerized device and the at least one wireless transmitting element are connected through a personal area network (PAN) created therebetween, the PAN having a predetermined functional distance. A signal is transmitted from the at least one wireless transmitting element to the wireless receiver through the PAN. A detection element is within the computerized device, wherein the detection element is positioned to detect a break in the PAN between the computerized device and the at least one wireless transmitting element, wherein the break in the PAN corresponds to the at least one wireless transmitting element positioned relative to the computerized device in a location beyond the predetermined functional distance of the PAN. A notification element is in communication with the detection element, wherein the notification element produces a notification of the detected break in the PAN.

The present disclosure can also be viewed as providing methods of notifying a relative object position. In this regard, one embodiment of such a method, among others, can be broadly summarized by the following steps: pairing a computerized device having a wireless communication receiver with a wireless transmitting element via a wireless communication connection; moving the wireless transmitting element beyond a predetermined distance from the computerized device; detecting a break in the wireless communication connection; and producing a notification in response to the detected break in the wireless communication connection.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is schematic diagram of an object position detection apparatus, in accordance with a first exemplary embodiment of the present disclosure.

FIG. 2 is schematic diagram of the object position detection apparatus of FIG. 1, in accordance with the first exemplary embodiment of the present disclosure.

FIG. 3 is an illustration of an object position detection apparatus, in accordance with a second exemplary embodiment of the present disclosure.

FIG. 4 is an illustration of an object having a wireless transmitting element of an object position detection apparatus, in accordance with a third exemplary embodiment of the present disclosure.

FIG. 5 is a flowchart illustrating a method for notifying a relative object position, in accordance with the first exemplary embodiment of the disclosure.

### DETAILED DESCRIPTION

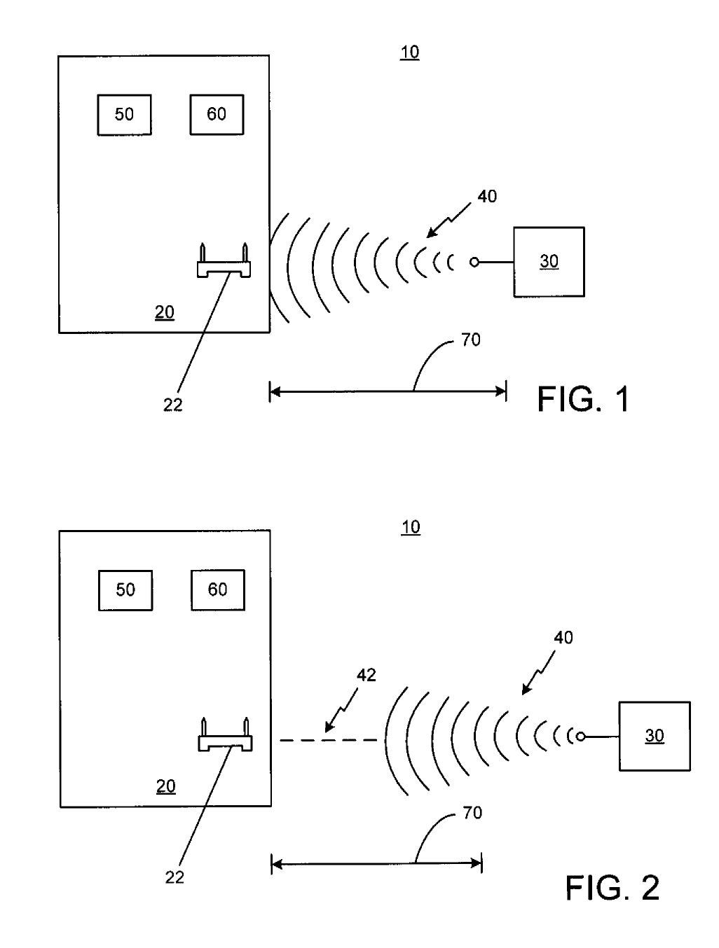

FIG. 1 is schematic diagram of an object position detection apparatus 10, in accordance with a first exemplary embodiment of the present disclosure. The object position detection apparatus 10, which may be referred to simple as ‘apparatus 10’ includes a computerized device 20 having a wireless receiver 22. A wireless transmitting element 30 is located remotely from the computerized device 20, wherein the computerized device 20 is paired with the wireless transmitting element 30 through a wireless communication connection 40. A detection element 50 is within the computerized device 20. The detection element 50 is positioned to detect a break in the wireless communication connection 40, wherein the break in the wireless communication connection 40 corresponds to a location of the wireless transmitting element 30 that is beyond a predetermined distance 70 from the computerized device 20. A notification element 60 is in communication with the detection element 50, wherein the notification element 60 produces a notification of the detected break in the wireless communication connection 40.

The apparatus 10 may be used for a variety of purposes relating to relative object position detection, including detecting the relative position of living and non-living objects and producing a notification of a relative position of a living or non-living object, as will be discussed herein. In accordance with this disclosure, the apparatus 10 may detect the relative position of an object by detecting a position of the object with reference to a current position or location of the computerized device 20. However, in addition to relative object position detection, the apparatus 10 may include components for detection of the object position relative to other devices and structures. For example, the apparatus 10 may detect the object position relative to the computerized device 20 as well as any other number of electronic devices, such as electronic detecting devices statically positioned within a building or facility.

The apparatus 10 includes a computerized device 20 which may include any type of computer, computer system, or other device utilizing a computer processor. For example, the computerized device 20 may include a personal computer (PC), a laptop computer, a notebook computer, a computerized cellular phone, a PDA, a computerized tablet device, or another device. Commonly, the computerized device 20 may be a personal cellular phone, such as an iPhone®, an Android™ phone, or any other cellular phone. The computerized device 20 may to have a network connection, such that the computerized device can communicate via the Internet through a hardwired connection or a wireless connection. This may include networks such as 2G, 3G, and/or 4G, any subsequent iteration or alternative means of wireless communication. The computerized device 30 may preferably be a mobile device that is carried by a user to any of the locations that the user may be present at. However, the computerized device 30 may also be a stationary device integrated within a substantially stationary network within a building or facility.

As is known within the industry, any computer-based device may include one or more processors, memory units, databases, and/or programs or software applications, all of which are considered within the scope of the present disclosure. For example, the computerized device 20 may have a computerized program installed within a memory device therein. The computerized program may be any application software, which may be referred to in the industry as an application, or simply an “app.” Current examples of these apps are commonly referred to by the entity that creates, markets or sells the app, such as Apps for iPhone® sold at an app store, or Google® apps. The app may include software code for performing a single action or multiple, related actions or tasks. The app may be compatible with, or used in conjunction with any other type of system software, middle ware or program.

The apparatus 10 may utilize a specific app to instruct functioning of the various components of the apparatus 10, or the apparatus 10 may utilize an existing app within the computerized device 20, or any combination thereof. For example, it may be common for the apparatus 10 to utilize existing software within the computerized device 20 for transmitting and receiving signals over the wireless communication connection 40, such as software associated with the functioning of Bluetooth® communication within a cellular phone. However, the apparatus 10 may also utilize an app that provides instructions for the detection element 50, the notification element 60, and other components of the apparatus 10. Of course, any apps or software that is required for proper functioning of the apparatus 10 may be downloaded by the user of the computerized device 20, or otherwise retrieved and stored on the memory of the computerized device 20.

The computerized device 20 includes a wireless communication receiver 22, which receives a wireless communication signal. This may include any type of wireless communication receiving device, configured for use with any type of wireless communication technology. For example, the wireless communication receiver 22 may be configured for use with Bluetooth™ technology, which uses radio-based frequency-hopping spread spectrum using 79 bands in the range 2,400-2,483.5 MHz. Bluetooth® technology is readily available, and commonly used with computers and cellular phones or other mobile devices. For example, a mobile device may have a Bluetooth® enabled platform for connecting to or pairing with other Bluetooth® enabled devices, namely, headsets and automotive-based Bluetooth® devices. This may allow communication on the mobile device via the Bluetooth® enabled device, which may allow for hands-free cellular phone use. It is noted that the computerized device 20 may also include a transmitting unit for transmitting a wireless signal, as may be dependent on the design of the apparatus 10.

The wireless transmitting element 30 is an independent device, with respect to the computerized device 20, but may work in conjunction with the computerized device 20. For example, the wireless transmitting element 30 may be a Bluetooth® based device that is independent of the computerized device 20. In other words, the wireless transmitting element 30 may be a separate and distinct device from the computerized device 20, but may function by communicating with the computerized device 20. The wireless transmitting element 30 may transmit an omnidirectional signal, or any number of signals to the computerized device 20. The signals may be transmitted continuously, at specific intervals, upon command or in accordance with any other instruction, all of which are considered within the scope of the present disclosure. Additionally, it is noted that the wireless transmitting element 30 may also be capable of receiving signals from the computerized device 20 or another device, but is only discussed herein with regards to transmission functioning.

As the wireless transmitting element 30 is an independent device from the computerized device 20, it may be located in a remote position from the computerized device 20. In accordance with this disclosure, the remote position of the wireless transmitting element 30 may be any position that is not the same as the position of the computerized device 20. For example, a remote position of the wireless transmitting element 30 may be 1 foot, 5 feet, 10 feet, 30 feet, or any other distance from the computerized device 20, including distances greater than 30 feet. For example, a wireless transmitting element 30 that is affixed to the shirt of a young child may be considered remote from the cellular phone, i.e., the computerized device 20 carried by the young child's parent when the child and parent are positioned side by side, within a few feet of one another, separated a large distance from one another, or positioned apart any other distance.

The wireless transmitting element 30 may be capable of pairing with the computerized device 20. This may be accomplished by creating a communication-based relationship between the wireless transmitting element 30 and the computerized device 20. The communication-based relationship may include any communication connection between the wireless transmitting element 30 and the computerized device 20. For example, a personal area network (PAN) may be created between the wireless transmitting element 30 and the computerized device 20. Within the PAN, signals may be directly transmitted between the wireless transmitting element 30 and the computerized device 20 to facilitate communication therebetween, or for facilitating communication to other devices and networks. Any communication or pairing between the wireless transmitting element 30 and the computerized device 20 may be secured to prevent unwanted and unauthorized interference. The communication or pairing may be based off of a link key or other shared key. The link key may allow for a secure connection between the computerized device 20 and the wireless transmitting element 30, which may allow the wireless transmitting element 30 to communication only with a computerized device 20 that it is paired to. As is known in the art, this connection may be verified through cryptographic authentication or another form of verification.

It is noted that any number of computerized devices 20 may be paired with any number of wireless transmitting element 30, as may be dependent on the design of the apparatus 10. For example, one single computerized device 20 may be paired with numerous wireless transmitting elements 30. For example, to establish a pairing, the computerized device 20 may provide a list of all devices compatible with the computerized device 20, commonly called ‘discovered devices’, and present that list to a user of the computerized device 20. The user may then choose which of the discovered devices to connect or pair to. Once a discovered device is selected, the computerized device 20 may then establish the secured connection between the computerized device 20 and the discovered device.

The computerized device 20 may establish the wireless communication connection 40 between the computerized device 20 and the wireless transmitting element 30 with the process and steps described above. Once established, the wireless communication connection 40 may remain between the computerized device 20 and the wireless transmitting element 30 until it is canceled, broken or interrupted, as will be discussed further. It is noted that the computerized device 20 may include an icon element on a display screen or graphical user interface (GUI) of the computerized device 20 that notifies a user about a pairing or connection.

The detection element 50 detects a break in the wireless communication connection 40 that has been established between the computerized device 20 and the wireless transmitting element 30. In accordance with this disclosure, the break in the wireless communication connection 40 may be any signal interruption or disruption, or signal loss of the wireless communication connection 40. Commonly, the break may correspond to the wireless transmitting element 30 moving beyond a predetermined distance 70 from the computerized device 20. The predetermined distance 70 may be considered a predetermined functional distance that is required for successful communication between the wireless transmitting element 30 and the computerized apparatus 20. As such, a distance between the wireless transmitting element 30 and the computerized apparatus 20 that is beyond the predetermined functional distance may result in a failed signal transmission.

For example, with Bluetooth® technology, the wireless communication connection 40 may be broken when the wireless transmitting element 30 is located approximately 33 feet from the computerized device 20. Thus, when the wireless transmitting element 30 is located 33 feet or more from the computerized device 20, the wireless communication connection 40 is broken and the wireless transmitting element 30 becomes unpaired with the computerized device 20. The wireless communication connection 40 may also become broken or unpaired at other distances, such as less than 30 feet, between 30 and 33 feet, and greater than 33 feet, depending on the components and design of the apparatus 10.

A notification element 60 is in communication with the detection element 50 and may provide or produce a notification of the break in the wireless communication connection 40 after the break is detected. The notification element 60 may provide any type of notification, including audio notifications, textual notifications, graphic notifications, message-based notifications, phone calls, physical notifications, or any combination thereof. These notifications may be displayed on a display screen or GUI of the computerized device 20, or transmitted to another device, such as another computer or cellular phone. The notification may be produced immediately subsequent to when the break is detected, or at some predetermined time subsequent to when the break is detected.

In one example, the notification element 60 changes an icon from one color to another, or changes one icon to another icon. For example, the notification element 60 may change an icon, such as the word “connected” which is displayed on the GUI of a cellular phone, to a “disconnected” icon having a different color. Of course, the icon may be any textual, graphic, or pictoral depiction on the GUI. The notification element 60 may also activate a light within the computerized device 10, such as an LED within a cellular phone. In another example, the notification element 60 activates an audible alarm transmitted from the computerized device 20, or a vibration-based alarm that vibrates the computerized device 20, depending on the current setting of the cellular phone. Other examples of notifications or notifying actions may include dialing a phone number, reading an alert script, sending an alert status to another computing device, updating a social medial program with a status change, highlighting an alert status, and/or controlling another device, such as turning on lights, sounding an alarm, turning on cameras or recording devices, etc. The notification may remain present until it is manually cleared by a user, or for any period of time.

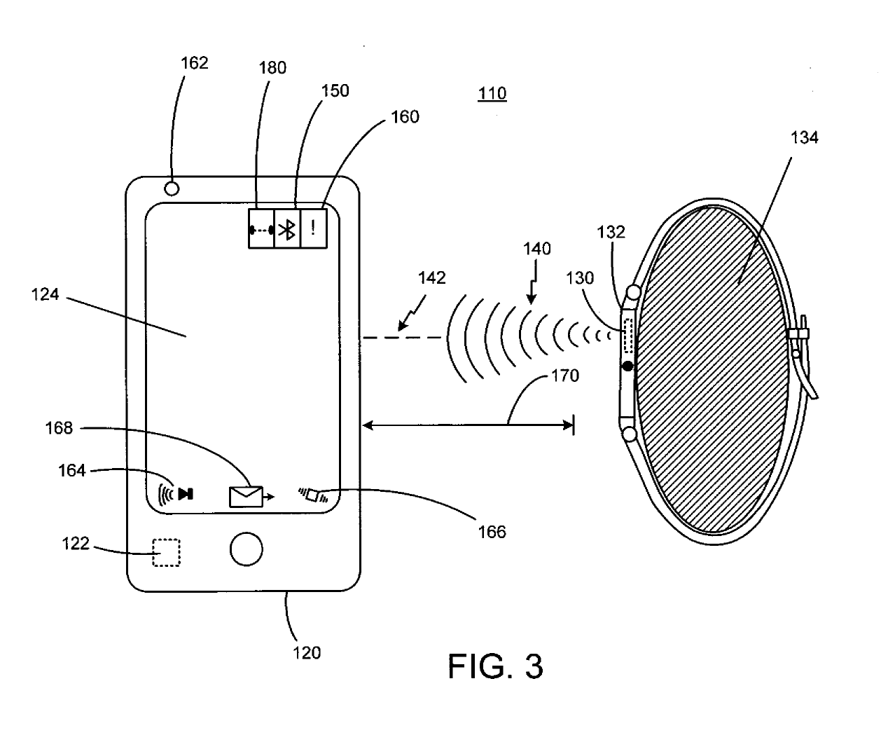

FIG. 2 is schematic diagram of the object position detection apparatus 10 of FIG. 1, in accordance with the first exemplary embodiment of the present disclosure. Specifically, FIG. 2 illustrates the apparatus 10 with the wireless transmitting element 30 moved beyond the predetermined distance 70 from the computerized device 20, such that the wireless receiver 22 is unable to receive a signal from the wireless transmitting element 30. When this occurs, the detection element 50 within the computerized device 20 may detect a break 42 within the wireless communication connection 40. The notification element 60 may then produce a notification of the broken wireless communication connection 40 to alert a user. In turn, the user may then identify where the object having the wireless transmitting element 30 attached thereto is located, and act accordingly.

FIG. 3 is an illustration of an object position detection apparatus 110, in accordance with a second exemplary embodiment of the present disclosure. The object position detection apparatus 110, which may be referred to simple as ‘apparatus 110’ may be substantially similar to the apparatus 10 of the first exemplary embodiment. Accordingly, the apparatus 110 includes a computerized device 120 having a wireless receiver 122. A wireless transmitting element 130 is located remotely from the computerized device 120, wherein the computerized device 120 is paired with the wireless transmitting element 130 through a wireless communication connection 140. A detection element 150 is within the computerized device 120. The detection element 150 is positioned to detect a break 142 in the wireless communication connection 140, wherein the break 142 in the wireless communication connection 140 corresponds to a location of the wireless transmitting element 130 that is beyond a predetermined distance 170 from the computerized device 120. A notification element 160 is in communication with the detection element 150, wherein the notification element 160 produces a notification of the detected break 142 in the wireless communication connection 140.

To illustrate the present disclosure better, consider the following example. The computerized device 120 may be a Bluetooth® enabled personal cellular phone used by an adult, and carried on the person of the adult. The cellular phone 120 may have a GUI 124 that the adult can use to see various components of the apparatus 110. As is shown in FIG. 3, the GUI 124 may display an icon for the detection element 150, an icon for the notification element 160, and an icon for a status element 180. The status element 180 may provide a current status of the wireless communication connection 140 between the wireless receiver 122 and the wireless transmitting element 130, thereby allowing the adult to determine that the wireless communication connection 140 is operational. As is discussed with respect to FIGS. 1-2, the notification element 160 may produce a notification through any number of ways, including by activating a light 162 on the cellular phone 120, by sounding an audible alarm 164 with the cellular phone 120, by vibrating the cellular phone 120 with a vibration notification 166, and/or by transmitting an electronic message 168. As is shown in FIG. 3, the audible alarm 164, the vibration notification 166, and the electronic message 168 are represented with icons.

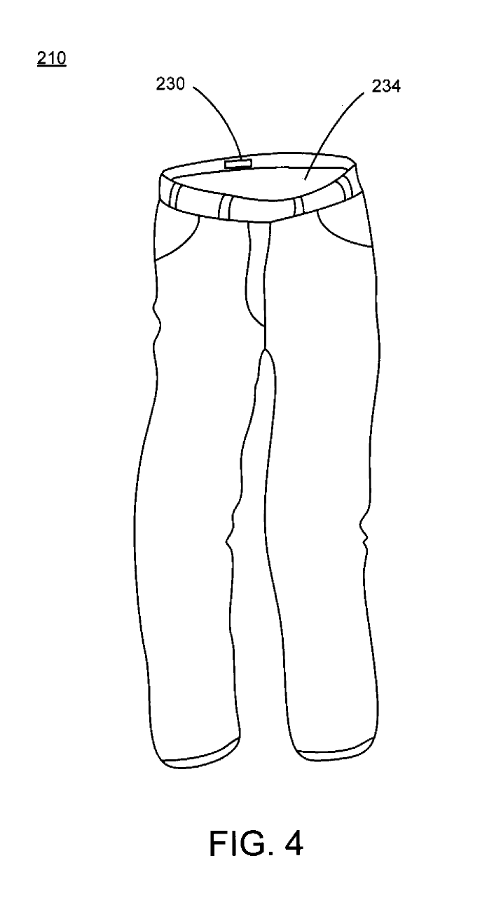

The wireless transmitting element 130 may be a small, Bluetooth® enabled transmitting chip located within a housing enclosure 132 that is attached to an object 134. The object 134 may include a living being, as is depicted in FIG. 3, or any structure, whereas the housing enclosure 132 may include any type of enclosure, such as a wristwatch, a piece of clothing, a collar, jewelry, shoes, wallets, purses, electronic device, and any other items of a child accompanying the adult. For example, when the object 134 is a dog or cat, it may be preferable for the wireless transmitting element 130 to be integrated into a collar, or when the apparatus 110 is used with small children, it may be preferable to integrally attach the wireless transmitting element 130 to an article of clothing of the child, as is discussed further in FIG. 4.

The wireless transmitting element 130 may be paired with the cellular phone 120, such that there is a continuous wireless communication connection 140 between the computerized device 120 and the wireless transmitting element 130 (in FIG. 3, the wireless communication connection 140 is illustrated with a break 142). When the child having the wireless transmitting element 130 is located close to the adult, i.e., 5, 10, or 20 feet from the adult, the wireless communication connection 140 remains unbroken (the computerized device 20 and the wireless transmitting element 130 remain paired). However, as is shown in FIG. 3, when the child wanders beyond the predetermined distance from the adult, such as beyond 33 feet from the adult, the wireless communication connection 140 becomes broken (the computerized device 120 and the wireless transmitting element 130 become unpaired). This break 142 in the wireless communication connection 140 is detected by the detection element 150.

The child's distant location from the adult may present unsafe conditions, such as hindering supervision of the child by the adult, making the child prone to getting lost, or even worse, making the child vulnerable to abduction. To prevent these problems, the notification element 160 produces a notification of the break in the wireless communication connection 140 immediately after the break 142 is detected. If this notification is an audio alarm, the adult can immediately attempt to locate the child. Since the notification is produced immediately after the wireless communication connection 140 is broken, the adult can attempt to easily locate the child through verbal and/or visual means. The time frame of notifying the adult of the child's location may be only a fraction of a second, a single second, or only a few seconds. Thus, the child can be located quickly thereby preventing any subsequent danger to the child.

A variety of variations and configurations may be used with the apparatus 110, all of which are considered within the scope of the present disclosure. For example, the apparatus 110 may have an override system to silence a notification that is created in error, such as when the break in the wireless communication connection is purposeful. The apparatus 110 may also allow a user to clear a past notification or reset the wireless communication connection 140 after it is broken. Other features and functions may also be present with, or used by any of the apparatuses disclosed herein.

It is also noted that the wireless transmitting element 130 may be located in a variety of places, including within jewelry, watches, clothing, shoes, wallets, purses, electronic device, household goods, and any other items. Accordingly, the apparatus may detect the relative object location of any of these items, thereby preventing or mitigating loss of the items, theft of the items, and/or misplacing the items. The apparatus 110 may be used in mobile locations, such as malls and shopping centers, but it may also be used in households, such as to monitor or detect the relative location of household items. For example, the apparatus 110 may be capable detecting the relative location of a television set relative to the house, thereby allowing for notification of removal of the television set due to theft or unauthorized taking.

FIG. 4 is an illustration of an object 234 having a wireless transmitting element 230 of an object position detection apparatus 210, in accordance with a third exemplary embodiment of the present disclosure. When the apparatus 210 is used with animals, small children, or other living beings that may be incapable of or unwilling to keep the wireless transmitting element 230 on their person, it may be preferable to integrally attach the wireless transmitting element 230 to an object 234 that is worn by or otherwise carried by the being. For example, as is shown in FIG. 4, the wireless transmitting element 230 may be integrally disposed within the waist band of child's pants. This allows for successful use of the apparatus 210 without interruption due to the child becoming separated from the wireless transmitting element 230. The same concept may be reproduced by integrally attaching the wireless transmitting element 230 within a hat, a belt, a shoe, a shirt, a jacket, or any other article of clothing that is worn by the child. The wireless transmitting element 230 may be integral, removable, or otherwise attachable to the object 234 by any means available.

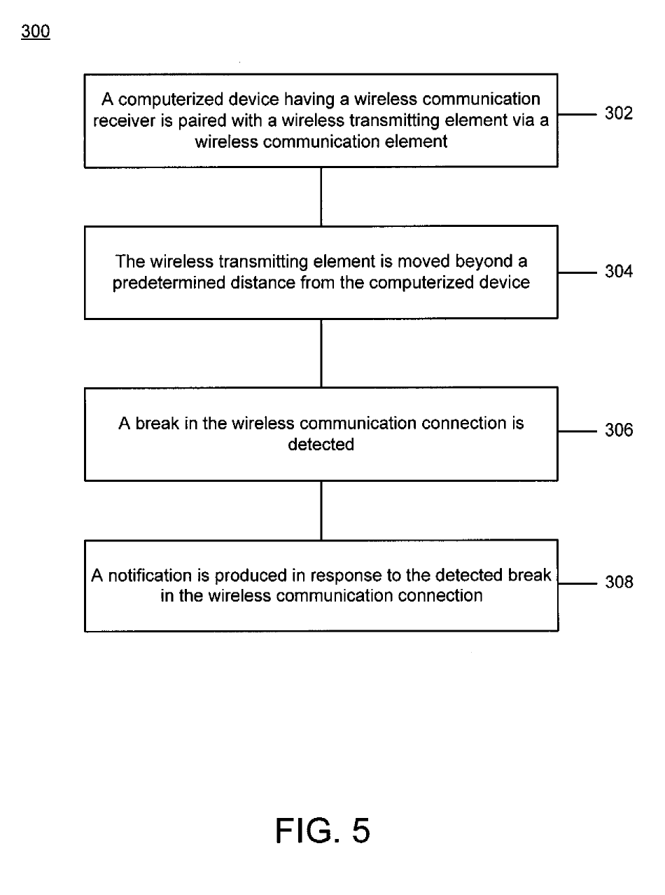

FIG. 5 is a flowchart 300 illustrating a method for notifying a relative object position, in accordance with the first exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 302, a computerized device having a wireless communication receiver is paired with a wireless transmitting element via a wireless communication connection, The wireless transmitting element is moved beyond a predetermined distance from the computerized device (block 304). A break in the wireless communication connection is detected (block 306). A notification is produced in response to the detected break in the wireless communication connection (block 308).

The method may include any additional number of steps, variations, or functions, including any steps, variations, or functions disclosed with respect to FIGS. 1-4 above. The method may also include any commonly used techniques or processes within the art, and/or inherent in the successful functioning of the method. For example the wireless transmitting element may be attached to a living being. The notification produced may include a variety of different notifications, including an audible alarm, a vibration within the computerized device, transmission of an electronic message from the computerized device, and/or displaying a visual icon on a graphical user interface of the cellular telephone.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. An object position detection apparatus comprising:
a computerized device having a wireless receiver;
a wireless transmitting element located remotely from the computerized device, wherein the computerized device is paired with the wireless transmitting element through a wireless communication connection;
a detection element within the computerized device, the detection element positioned to detect a break in the wireless communication connection, wherein the break in the wireless communication connection corresponds to a location of the wireless transmitting element that is beyond a predetermined distance from the computerized device; and
a notification element in communication with the detection element, wherein the notification element produces a notification of the detected break in the wireless communication connection.

2. The object position detection apparatus of claim 1, wherein the wireless transmitting element transmits at least one signal through the wireless communication connection between 2,400-2,483.5 MHz.

3. The object position detection apparatus of claim 1, wherein the computerized device further comprises at least one of a personal computer, a cellular telephone, a tablet computer, and a personal digital assistant.

4. The object position detection apparatus of claim 1, further comprising a housing enclosure containing the wireless transmitting element, wherein the housing enclosure is attachable to an object.

5. The object position detection apparatus of claim 4, wherein the housing enclosure is attachable to an article of clothing worn by the living being.

6. The object position detection apparatus of claim 4, wherein the object is a living being.

7. The object position detection apparatus of claim 6, wherein the housing enclosure is attachable to the living being with at least one of a bracelet, a necklace, and a collar.

8. The object position detection apparatus of claim 1, further comprising a graphical user interface (GUI) within the computerized device, wherein the notification of the detected break in the wireless communication connection is visually displayed on the GUI.

9. The object position detection apparatus of claim 1, wherein the notification of the detected break in the wireless communication connection further comprises at least one of an audible alarm produced by the computerized device and a vibration of the computerized device.

10. The object position detection apparatus of claim 1, wherein the notification of the detected break in the wireless communication connection further comprises an electronic message transmitted from the computerized device.

11. The object position detection apparatus of claim 1, further comprising a status element within the computerized device and in communication with the wireless transmitting element, wherein the status element provides a current status of the wireless communication connection between the wireless receiver and the wireless transmitting element.

12. The object position detection apparatus of claim 1, wherein the wireless transmitting element further comprises a plurality of distinct wireless transmitting elements, each positioned remote from another and each paired with the computerized device through the wireless communication connection, wherein the detection element is positioned to detect a break in the wireless communication connection for each of the plurality of distinct wireless transmitting elements.

13. The object position detection apparatus of claim 1, wherein the wireless communication connection is secured with at least one key.

14. A system for alerting a relative location of a living being, the system comprising:
a computerized device having a wireless receiver;
at least one wireless transmitting element attached to a living being, wherein the living being is located remotely from the computerized device and is movable independent of the computerized device, wherein the computerized device and the at least one wireless transmitting element are connected through a personal area network (PAN) created therebetween, the PAN having a predetermined functional distance;
a signal transmitted from the at least one wireless transmitting element to the wireless receiver through the PAN;
a detection element within the computerized device, the detection element positioned to detect a break in the PAN between the computerized device and the at least one wireless transmitting element, wherein the break in the PAN corresponds to the at least one wireless transmitting element positioned relative to the computerized device in a location beyond the predetermined functional distance of the PAN; and
a notification element in communication with the detection element, wherein the notification element produces a notification of the detected break in the PAN.

15. The system for alerting a relative location of a living being of claim 14, wherein the predetermined functional distance of the PAN is 33 feet.

16. A method for notifying a relative object position, the method comprising the steps of:
pairing a computerized device having a wireless communication receiver with a wireless transmitting element via a wireless communication connection;
moving the wireless transmitting element beyond a predetermined distance from the computerized device;
detecting a break in the wireless communication connection; and
producing a notification in response to the detected break in the wireless communication connection.

17. The method for notifying a relative object position of claim 16, further comprising the step of attaching the wireless transmitting element to a living being.

18. The method for notifying a relative object position of claim 16, wherein the step of producing the notification further comprising the step of creating at least one of an audible alarm and a vibration within the computerized device.

19. The method for notifying a relative object position of claim 16, wherein the step of producing the notification further comprising the step of transmitting an electronic message from the computerized device.

20. The method for notifying a relative object position of claim 16, wherein the computerized device is a cellular telephone, wherein the step of producing the notification further comprises displaying a visual icon on a graphical user interface of the cellular telephone.
